(19) United States
(12) Patent Application Publication
(10) Pub. No.: US 2009/0112387 A1
(43) Pub. Date: Apr. 30, 2009

(54) Unmanned Vehicle Control Station

(76) Inventors: Darin G. Kabalkin, Falls Church, VA (US); Alan G. Hupke, Berryville, VA (US)

Correspondence Address: BAKER BOTTS LLP, 2001 ROSS AVENUE, 6TH FLOOR, DALLAS, TX, 75201-2980, US

(21) Appl. No.: 11/929,456

(22) Filed: Oct. 30, 2007

(51) Int. Cl. G05D 1/00; G06F 3/14; G06F 19/00

(52) U.S. Cl. 701/23

(57) ABSTRACT

According to one embodiment, a control station includes a heads-down display and at least heads-up display that may be viewed from a single position. The heads-down display is coupled to an unmanned vehicle control system that is operable to control an unmanned vehicle. The at least one heads-up display is adjacent to the heads-down display and operable to operable to display a composite image of the unmanned vehicle's environment. The composite image comprising a rendered image that is generated by a terrain rendering engine.

### TECHNICAL FIELD OF THE DISCLOSURE

This disclosure relates generally relates to unmanned vehicle systems, and more particularly, to an unmanned vehicle control station and a method of using the same.

### BACKGROUND OF THE DISCLOSURE

Unmanned vehicles generally refer to a type of vehicle that operates without an onboard pilot or driver. Control of unmanned vehicles are typically provided by an unmanned vehicle control system that communicates with one or more unmanned vehicles using a wireless radio frequency (RF) communications link. Various types of unmanned vehicles have been designed for various purposes and may include, for example, aircraft that travel through the air, land-based vehicles that travel over the ground, and boats that travel over the surface of the water.

### SUMMARY OF THE DISCLOSURE

According to one embodiment, a control station includes a heads-down display and at least one heads-up display that may be viewed from a single position. The heads-down display is coupled to an unmanned vehicle control system that is operable to control an unmanned vehicle. The at least one heads-up display is adjacent to the heads-down display and operable to operable to display a composite image of the unmanned vehicle's environment. The composite image comprising a rendered image that is generated by a terrain rendering engine.

Some embodiments of the present invention may provide numerous technical advantages. A technical advantage of one embodiment may be improved ergonomic functionality provided by dedicated display of composite images of the unmanned vehicle's environment. Operation of the unmanned vehicle may entail recognizing geospatially related information in a composite image of the unmanned vehicle's environment and providing appropriate control of the unmanned vehicle in response to this information. Known unmanned vehicle control stations, however, typically present this information in multiple images, such as two-dimensional maps, video images, payload displays, and aviation indicators that are alternatively viewed. Alternative viewing of these images may be burdensome due to the necessity of mentally merging of information provided by each image. The unmanned vehicle control station of the present invention alleviates the need for switching between composite images and the heads-down display by providing a separate heads-up display for dedicated view of these composite images to the user.

Although specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description.

### BRIEF DESCRIPTION OF THE DRAWINGS

A more complete understanding of embodiments of the disclosure will be apparent from the detailed description taken in conjunction with the accompanying drawings in which:

FIG. 1 is a diagram of a unmanned vehicle system on which one embodiment of an unmanned vehicle control station may be implemented;

FIG. 2 is a perspective view of a physical layout of the unmanned vehicle control station of FIG. 1;

FIG. 3 is a top view of the physical layout of FIG. 2;

FIG. 4 is an example composite image and one or more superimposed overlaid images that may be shown by the heads-up display of FIG. 1; and

FIG. 5 is a flowchart showing a series of actions that may be performed by a user of the unmanned vehicle control station of FIG. 1.

### DETAILED DESCRIPTION OF EXAMPLE EMBODIMENTS

Control of unmanned vehicles may be facilitated by unmanned vehicle control stations that communicate with unmanned vehicles using a wireless communication link. To promote standardization of various types of unmanned vehicles, a number of unmanned vehicle messaging protocols have been established. The Joint Architecture for Unmanned Systems (JAUS) is one particular messaging protocol that has been implemented for use with unmanned vehicles by the United States Department of Defense. The STANdardization AGreement (STANAG) 4586 protocol is another messaging protocol that has been implemented for use with unmanned vehicles. The standardization agreement 4586 specification, which defines its associated messaging protocol, has been written by member nations of the North Atlantic Treaty Organization (NATO) for the purpose of encouraging interoperability of unmanned vehicles among each member nation.

Known unmanned vehicle control stations using messaging protocols, such as described above, incorporate a computing system with a user interface for interacting with a user and displaying various aspects of the unmanned vehicle's operating characteristics. The generally sophisticated nature of modern unmanned vehicles, however, may utilize a relatively large number of operating characteristics that may require more than one user to administer control of the unmanned vehicle throughout its mission.

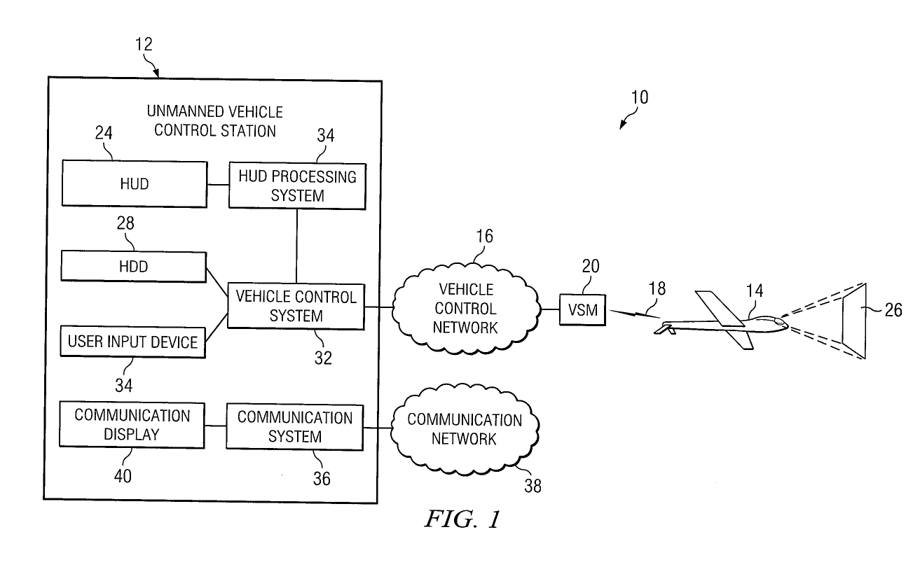

FIG. 1 shows one embodiment of a unmanned vehicle system 10 that may benefit from the teachings of the present disclosure. Unmanned vehicle system 10 includes an unmanned vehicle control station 12 that communicates with an unmanned vehicle 14 through a vehicle control network 16 and a wireless link 18. In one embodiment, unmanned vehicle system 10 is a standardization agreement 4586 compliant system in which a vehicle specific module 20 is incorporated for translation of messages from unmanned vehicle control station 12 using the standardization agreement 4586 messaging protocol to a messaging protocol suitable for communication with the unmanned vehicle 14.

Unmanned vehicle control station 12 may have at least one heads-up display 24 for display of one or more composite images of the unmanned vehicle's 14 environment and a heads-down display 28 for display of various operating characteristics of the unmanned vehicle 14. Heads-up display 24 and heads-down display 28 may be any suitable display device, such as a cathode ray tube (CRT), or a liquid crystal display (LCD). According to the teachings of the present disclosure, heads-up display 24 may be configured on a different display device from which the heads-down display 28 is configured. In this manner, heads-up display 24 may provide a dedicated view of one or more composite images for the user.

Certain embodiments incorporating a heads-down display 28 and a separate heads-up display 24 may provide an ergonomic advantage over known unmanned vehicle control stations in that simultaneous view may be provided for composite images of the unmanned vehicle's environment and operating characteristics used to control the unmanned vehicle 14. Known unmanned vehicle control stations typically use alternatively selectable screens for display of operating characteristics and other imagery, such as video images 26. This mode of operation, however, may be cumbersome for situations in which the user wishes to simultaneously view video images 26, other geospatially related information, and operating characteristics during operation of the unmanned vehicle 14. The user may also be limited from reacting quickly due to the need of manually selecting a desired screen view in response to various transient situations that may arise during operation of the unmanned vehicle 14.

Unmanned vehicle control station 12 includes a vehicle control system 32 that is configured to transmit and receive messages with unmanned vehicle 14 and generate display information that is displayed by heads-down display 28. Vehicle control system 32 may be implemented with a processor executing computer instructions stored in a memory. In one embodiment, unmanned vehicle control station 12 may incorporate one or more user input devices 34 for controlling the unmanned vehicle 14 and/or requests for information from the unmanned vehicle 14. User input devices 34 may be any suitable device for entry of information to vehicle control system 32, such as a keyboard, a pointing device, a mouse, and/or one or more joysticks.

Heads-down display 28 may be configured to display various operating characteristics associated with operation of the unmanned vehicle 14. In one embodiment, operating characteristics may be provided by a graphical user interface (GUI) having a number of interactively controllable buttons or knobs for controlling the operation of unmanned vehicle and/or a number of display fields for displaying various operating conditions of the unmanned vehicle 14. For example, a particular unmanned vehicle 14, such as an unmanned aerial vehicle (UAV) may experience various operating conditions, such as wind speed, engine speed, altitude, ambient temperature, ambient pressure, or other weather related conditions around the unmanned vehicle 14. Heads-down display 28 may also display information regarding the condition of components of the communications link, such as the vehicle control network 16, vehicle specific module 20, and/or wireless link 18.

Unmanned vehicle control station 12 may include a heads-up display processing system 34 that displays a composite image of the unmanned vehicle's environment. In one embodiment, the heads-up display processing system 34 may include a terrain rendering engine that renders the composite image from a geode and digital elevation and terrain data (DETD). Heads-up display processing system 34 may be any suitable type of computing system implemented with a processor executing computer instructions stored in a memory. In one embodiment, heads-up display processing system 34 may include a number of computing systems corresponding to a multiple number of heads-up displays 24 configured in the unmanned vehicle control station 12. Multiple heads-up displays 24 may enable dedicated view of multiple composite images produced by the heads-up display processing system 34. As will be described in greater detail below, the heads-up display processing system 34 may also be operable to superimpose overlaid images over the composite image formed on heads-up displays 24.

In one embodiment, unmanned vehicle control station 12 may include a communication system 36 that is coupled to a communication network 38. Communication system 36 may be implemented with a processor executing computer instructions stored in a memory. Communication network 38 may be any type of network suitable for communication of information between users and may be, for example, the Internet, an intranet, or a virtual private network (VPN) configured within another network. Communication system 36 is coupled to a communication display 40 that is disposed in such a manner such that the user may view the communication display 40, the at least one heads-up display 24, and the heads-down display from a single position. The communication system 36 may be configured to provide any suitable communication services, such as e-mail or instant messaging (IM) services. In one particular embodiment, communication system 36 may incorporate a common operational picture (COP) service. A common operational picture service generally refers to a type of geographical information system (GIS) that is configured to communicate geo-spatially related information among a number of remotely located users. The common operational picture service generally provides a commonly viewable map on which data from various sensors are displayed in a real-time manner at geographically oriented locations on the map for view by the users.

In one embodiment, the vehicle control system 32 and its associated vehicle control network 16 is decoupled from communication system 36 and its associated communication network 38. That is, communication system 36 may be implemented on a particular computing system that is separate from another computing system on which the vehicle control system 32 is implemented. In this manner, the vehicle control system 32 may be protected from security breeches caused by unwanted intrusion from hackers or other types of malware, such as viruses that may compromise the reliability of the unmanned vehicle control system 10.

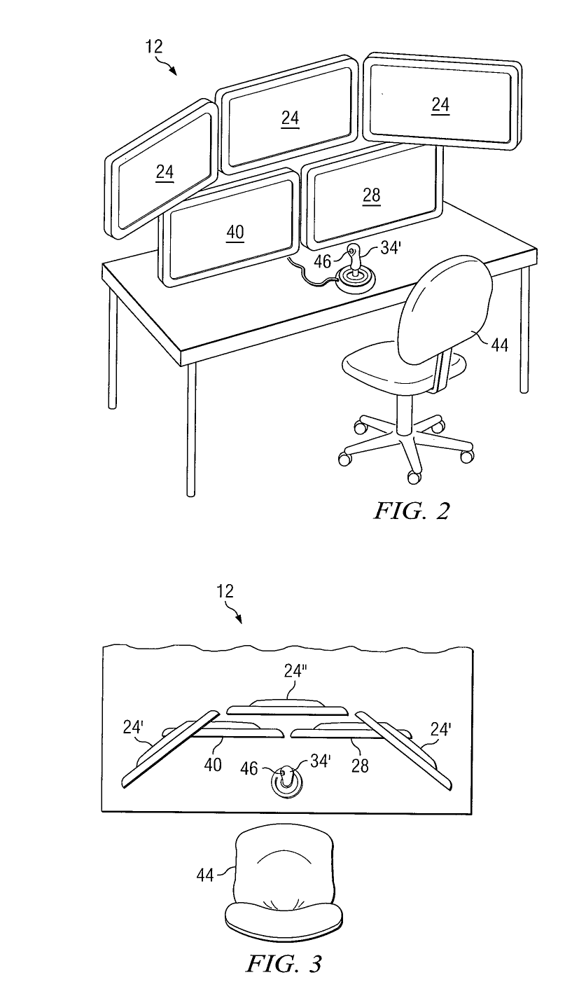

FIG. 2 is a perspective view of one embodiment of a physical layout of the unmanned vehicle control station 12 that may be implemented for use with unmanned vehicle system 10. In this particular embodiment, five individual displays are configured for simultaneous view by the user from a single position. Of these five displays, three heads-up displays 24 are disposed adjacent to each other in a side-by-side configuration. The two other displays include heads-down display 28 that is operable to display various operating characteristics as described above and communication display 40 for display of various communication services for the user.

According to the teachings of the present disclosure, the heads-up display 24, heads-down display 28, and optional communication display 40 may be configured for view by a user from essentially one position. That is, the user may be able to view the heads-up display 24, heads-down display 28, and optional communication display 40 without significant movement from one location to another. In the particular embodiment shown, a chair 44 is provided for administration of the unmanned vehicle control station 12 from essentially one position. It should be appreciated that other configurations for providing a user position may be utilized, such as from a standing position. In this particular embodiment, the chair 44 may allow viewing the heads-up display 24, heads-down display 28, and optional communication display 40 without movement from the chair 44 or significant movement of the chair 44 to a different location.

A joystick 34′, which is a type of user input device 34, may be provided for control of unmanned vehicle 14. In one embodiment, joystick 34′ may have one or more control knobs 46 that are configured to actuate one or more corresponding functions on the unmanned vehicle 14 and/or the vehicle control system 32. Control knobs 46 may include switches, such as momentary switches or toggle switches that control various functions of the unmanned vehicle 14, such as a “check-6” function, a “check-3” function, a “check-9” function, a push-to-talk function, a weapons release function, and/or a laser function. The term “check-6”, “check-9”, and “check-3” generally refers to the act of viewing an image behind, to the left, and to the right, respectively, of the unmanned vehicle 14. Control knobs 46 may also include rotary knobs for proportional control of various functions, such as engine throttle, a cursor pointer, an autopilot break, one or more mouse movement functions, a zoom function, a track grow function, and various control surfaces of the unmanned vehicle 14. In one embodiment, these control knobs 46 may be dedicated to actuate or control a single particular function.

Particular embodiments incorporating control knobs 46 that are dedicated to specific functions may provide an advantage in that control of various functions may be provided in an enhanced ergonomic manner. Known unmanned vehicle control stations provide control of various functions of the unmanned vehicle 14 and/or vehicle control system 32 using pull down menus of a graphical user interface (GUI) or various control knobs that provide control of multiple functions. This mode of control, however, typically requires a prescribed sequence of actions that may be tedious or cumbersome for the user. The dedicated control knobs 46 of the present disclosure may alleviate this problem by enabling control of various functions using a single actuation from the user.

FIG. 3 is a plan view of the physical layout of the unmanned vehicle control station 12 of FIG. 2. As shown, the three heads-up displays 24 are disposed adjacent to one another in a side-by-side configuration to facilitate viewing of geospatially related information in a manner similar to a view that may be seen from cockpit windows of an aircraft. The two outer heads-up displays 24′ are disposed at an angle relative to the center heads-up display 24″ such that the three heads-up displays form a generally concave-shaped viewing surface. In one embodiment, composite images displayed the displays 24 may be contiguously aligned to provide a relatively seamless view of the unmanned vehicle's environment. In this manner, the three heads-up displays 24 may provide a panoramic view of the unmanned vehicle's 14 environment that may provide enhanced view of the unmanned vehicle's environment than is available using known unmanned vehicle control stations.

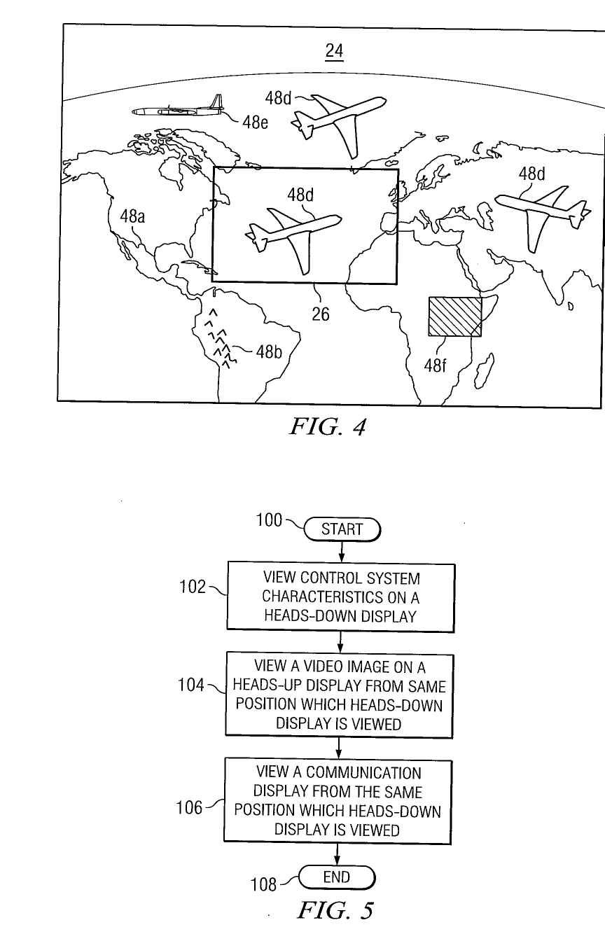

FIG. 4 is an example composite image that may be displayed on one of the heads-up display 24 of the unmanned vehicle control station 12. As previously described, the heads-up display 24 may be operable to display a composite image of the unmanned vehicle's environment. In one embodiment, the composite image may be include geospatially related information derived from any suitable terrain rendering engine. For example, the composite image may be a three-dimensional image derived from one particular geode that is superimposed with digital elevation and terrain data (DETD).

In one embodiment, heads-up display 24 may also be operable to display one or more geo-spatially oriented overlaid images 48 over the composite image. In this manner, the heads-up display 24 may be annotated with two-dimensional images and three-dimensional images of objects and events relevant to the operation of the unmanned vehicle. Overlaid images 48 may be any type of image representing geo-spatially related information.

Overlaid image 48 may be a three-dimensional world annotation, such as a political boundary 48a, digital elevation and terrain data 48b, a manned vehicle 48e, one or more other unmanned vehicles 48d. In other embodiments, three-dimensional world annotation may be a threat volume due to adverse weather conditions, an enemy weapon system, an airspace boundary imposed by civilian air traffic control or other airspace control authority, a bingo-fuel range boundary, a planned or actual route for the unmanned vehicle 14, the track of another manned or unmanned air, sea, ground or undersea vehicle, a geospatially-referenced mission task requests, or a pop-up information window.

In another embodiment, overlaid image 48 may be a geospatially rendered image, such as an image generated by a video camera, an infrared camera, or a radar sensor. In the particular embodiment shown, video image 26 from unmanned vehicle 14 is superimposed on composite image. In other embodiments, overlaid image 48 may be a heads-up annotation that includes textual information, such as position, speed, and/or orientation of the unmanned vehicle 14.

Overlaid images 48 may be provided as an icon, a vector graphic symbol, a photograph, or other suitable visual indicating mechanism. These overlaid images 48 may be geo-spatially referenced at particular locations by vehicle control system 32 such that they may be superimposed over the composite image at their appropriate location on heads-up display 24.

FIG. 5 shows one embodiment of a series of actions that may be performed for using the unmanned vehicle control station 12 according to the teachings of the present disclosure. In act 100, the process is initiated. The process may be started by initializing the heads-up display processing system 34, vehicle control system 32, and communication system 36, establishing communication between the unmanned vehicle control system 32 and unmanned vehicle 14, and launching the unmanned vehicle 14 on a mission.

In act 102, the user may view a number of control system characteristics on the heads-down display 28. Control system characteristics may include various operating conditions of the unmanned vehicle 14. In one embodiment, heads-down display 28 may generate images generated by a vehicle control system 32 that communicates with the unmanned vehicle 14 using a standardization agreement 4586 compliant messaging protocol.

In act 104, the user may view the composite image on a heads-up display 24 from the same position in which the heads-down display 28 is viewed. That is, the heads-up display 24 may be adjacent to and face the same general direction as the heads-down display 28 such that the user may view both without undue movement from a single position. In a particular embodiment, the heads-up display 24 may include three displays that are adjacent to each other in a side-by-side configuration for display of a panoramic view of the unmanned vehicle's 14 environment. In another embodiment, the user may view an overlaid image superimposed on the heads-up display 24.

In act 106, the user may view a communication display 40 from the same position in which heads-down display 28 is viewed. The communication display 40 may display any suitable communication service provided by communication system 36. In one embodiment, communication display 40 may display a common operational picture (COP) service.

The previously described process continues throughout the mission of the unmanned vehicle 14. When the mission of the unmanned vehicle 14 is complete, the unmanned vehicle control station 12 may be halted in act 108.

A unmanned vehicle control station 12 has been described that provides at least one heads-up display 24 that provides a dedicated view of the unmanned vehicle's 14 environment from the same position in which the heads-down display 24 is viewed. The dedicated view of the unmanned vehicle's environment provided by the heads-up display 24 may alleviate alternative viewing of various geospatially related images from a single display. Thus, certain embodiments may provide an enhanced ergonomic use for reduction of user fatigue and enable operation of the unmanned vehicle 14 by a single user. The unmanned vehicle control station 12 may also include a number of dedicated control knobs 46 that are each dedicated to operation of a single function for enhanced ergonomic use in some embodiments. Thus, the unmanned vehicle control station 12 may be relatively easier to use than known unmanned vehicle control systems.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. A control station comprising:
an unmanned vehicle control system operable to control an unmanned vehicle, the unmanned vehicle control system having a heads-down display operable to display a plurality of operating characteristics of the unmanned vehicle;
a plurality of heads-up displays that are adjacent to each other in a side-by-side configuration, the plurality of heads-up displays being adjacent the heads-down display such that a user may view the plurality of heads-up displays and the heads-down display from a single position, the plurality of heads-up displays operable to display a corresponding plurality of composite images of the unmanned vehicle's environment, the heads-up display being operable to display an overlaid image on the plurality of composite images; and
a communication system having a communication display that is adjacent to the heads-down display in a side-by-side configuration such that the user may view the at least one heads-down display and the communication display from a single position.

2. The control system of claim 1, wherein the plurality of heads-up displays comprises three heads-up displays, the three heads-up displays comprises a center display and two outer displays, the two outer displays disposed at an angle relative to the center display such that the three heads-up displays form a generally concave-shaped viewing surface.

3. The control station of claim 1, wherein the unmanned vehicle control system is a Core unmanned aerial vehicle control station (CUCS) that communicates with the unmanned vehicle using a standardization agreement 4586 messaging protocol.

4. The control station of claim 1, wherein the communication system has a common operational picture (COP) communication service.

5. A control station comprising:
an unmanned vehicle control system operable to control an unmanned vehicle, the unmanned vehicle control system having a heads-down display operable to display a plurality of operating characteristics of the unmanned vehicle; and
at least one heads-up display being adjacent to the heads-down display such that a user may view the at least one heads-up display and the heads-down display from a single position, the at least one heads-up display operable to display a composite image of the unmanned vehicle's environment, the composite image comprising a rendered image.

6. The control station of claim 5, wherein the at least one heads-up display comprises three heads-up displays that are adjacent to each other in a side-by-side configuration, the three heads-up displays operable to display the composite image in a panoramic view.

7. The control station of claim 6, wherein each of the three heads-up displays comprises a center display and two outer displays, the two outer displays disposed at an angle relative to the center display such that the three heads-up displays form a generally concave-shaped viewing surface.

8. The control station of claim 5, wherein the unmanned vehicle control system is a core unmanned aerial vehicle control station (CUCS) that communicates with the unmanned vehicle using a standardization agreement 4586 messaging protocol.

9. The control station of claim 5, wherein the heads-up display is further operable to display an overlaid image on the composite image, the overlaid image selected from the group consisting of a three-dimensional annotation, a geospatially rendered image, and a heads-up annotation.

10. The control station of claim 5, further comprising a communication system for communication of the user with other people, the communication system having a communication display adjacent to the heads-down display in a side-by-side configuration such that the user may view the communication display and the heads-down display from a single position.

11. The control station of claim 10, wherein the communication system has a common operational picture (COP) communication service.

12. The control station of claim 5, wherein the unmanned vehicle control system includes at least one dedicated function knob that is configured to control a function of the unmanned vehicle, the dedicated function knob being selected from the group consisting of a “check-6” function, a push-to-talk function, a weapons release function, a laser function, an engine throttle function, a cursor pointer function, an autopilot break function, one or more mouse movement functions, a zoom function, a track grow function, and a control surface of the unmanned vehicle.

13. The control station of claim 12, wherein the at least dedicated function knob is configured on a joystick controller.

14. A method for using an unmanned vehicle control station comprising:
viewing, on a heads-down display, a plurality of control system characteristics associated with operation of an unmanned vehicle; and
viewing, from essentially the same position from which the heads-down display is viewed, a composite image on a heads-up display that is adjacent the heads-down display, the composite image comprising a rendered image that is an environmental view of the unmanned vehicle.

15. The method of claim 14, wherein viewing a composite image on a heads-up display further comprises viewing three composite images on three heads-up displays, the three composite images comprising a panoramic view of the unmanned vehicle.

16. The method of claim 14, further comprising receiving the plurality of control system characteristics from the unmanned vehicle using a standardization agreement 4586 messaging protocol.

17. The method of claim 14, further comprising viewing an overlaid image on the composite image, the overlaid image selected from the group consisting of a three-dimensional annotation, a geospatially rendered image, and a heads-up annotation.

18. The method of claim 14, further comprising viewing a communication display from essentially the same position from which the heads-down display is viewed.

19. The method of claim 18, wherein viewing a communication display from essentially the same position from which the heads-down display is viewed further comprises viewing a common operational picture (COP) communication system from essentially the same position from which the heads-down display is viewed.

20. The method of claim 14, further comprising actuating at least one dedicated control knob that is dedicated to control a single function that is selected from the group consisting of a “check-6” function, a push-to-talk function, a weapons release function, a laser function, an engine throttle function, a cursor pointer function, an autopilot break function, one or more mouse movement functions, a zoom function, a track grow function, and a control surface of the unmanned vehicle.

21. The method of claim 20, wherein actuating the at least one dedicated control knob further comprises actuating the at least one control knob that is disposed on a joystick.
